(19) United States
(12) Patent Application Publication
(10) Pub. No.: US 2007/0033616 A1
(43) Pub. Date: Feb. 8, 2007

(54) Ascertaining show priority for recording of tv shows depending upon their viewed status

(76) Inventor: Srinivas Gutta, Veldhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,978

(22) PCT Filed: May 24, 2004
(86) PCT No.: PCT/IB04/01775

§ 371 Date: Nov. 17, 2005

Related U.S. Application Data
(60) Provisional application No. 60/474,820, filed on May 30, 2003.

(51) Int. Cl. H04N 5/445; G06F 3/00; G06F 13/00; H04N 7/00; H04N 5/91

(52) U.S. Cl. 725/58; 386/46; 725/46; 725/45

(57) ABSTRACT

A recommending system which performs compression on recommended shows based on recommender scores. If a show is highly recommended, the show will not be compressed. If, however, a show is not recommended as highly it will be compressed before storing the show. This provides more storage capacity. The compression rate can be varied depending on the recommender score.

The present invention relates to methods and devices for recommending and recording television programming, and more particularly to a method and device for performing compression on recorded shows based on recommender scores.

As the number of channels available to television viewers has increased, along with the diversity of the programming content available on such channels, it has become increasingly challenging for television viewers to identify and record television programs of interest In addition, since storage capacity is limited, it has become difficult to store all the programs that may interest the viewer. Historically, television viewers identified television programs of interest by analyzing printed television program guides. Typically, such printed television program guides contained grids listing the available television programs by time and date, channel and title.

More recently, a number of tools have been proposed and become available for recommending television programming. The Tivo® system, for example, commercially available from Tivo, Inc., of Sunnyvale, Calif., allows viewers to rate shows using a “Thumbs Up and Thumbs Down” feature and thereby indicate programs that the viewer likes and dislikes, respectively. Thereafter, the TiVo® receiver matches the recorded viewer preferences with received program data, such as an electronic program guide (EPG), to make recommendations tailored to each viewer. The TiVo® then records the recommended shows on a hard disk for future viewing by the user.

There are typically two kinds of recommenders, implicit and explicit. Implicit television program recommenders generate television program recommendations based on information derived from the viewing history of the viewer, in a non-obtrusive manner. FIG. 1 illustrates the generation of a viewer profile 40 using a conventional implicit television program recommender 60. The implicit viewer profile 40 is derived from a viewing history 25, indicating whether a given viewer liked or disliked each program. As shown in FIG. 1, the implicit television program recommender 60 processes the viewing history 25, in a known manner, to derive an implicit viewer profile 40 containing a set of inferred rules that characterize the preferences of the viewer. Thus, an implicit television program recommender 60 attempts to derive the viewing habits of the viewer based on the set of programs the viewer liked or disliked.

Explicit television program recommenders, on the other hand, explicitly question viewers about their preferences for program attributes, such as title, genre, actors, channel, and date/time to derive viewer profiles and generate recommendations. U.S. Ser. No. 09/666,401 titled METHOD AND APPARATUS FOR GENERATING RECOMMENDATION SCORES USING IMPLICIT AND EXPLICIT VIEWING PREFERENCES to Kaushal Kurapati, David J. Schaffer, and Srinivas Gutta (hereby incorporated by reference) describes a television programming recommender that generates television program recommendations based on a combined implicit/explicit program recommendation score. Thus, the disclosed television programming recommender combines the explicit viewing preferences of viewers with their television viewing behavior to generate program recommendations based on explicit recommendation scores and implicit recommendation scores. In this system, the invention computes a combined recommendation score based on the explicit and implicit scores. These implicit and explicit scores can be biased towards the explicit scores and the combined recommendation score can be computed using a weighted linear mapping.

The problem with all the present recommenders described is that the storage space is limited for the recording of recommended shows. Many times the storage space isn't enough to store a newly recommended program causing a decision to be made, whether to delete an unviewed recording or not record the newly recommended program. Accordingly, there is a need to implement a method and device to utilize storage space in an efficient manner.

Generally, a television recommender and/or recording method and device are described which determines from the recommender score the compression level that the recommended program should be recorded at. This adds additional storage capacity because some programs will be stored in a compressed format using less storage space.

The system in general looks at the recommender score for a particular show. If the recommender score is between, for example, 99% and 100% match, then the show is recorded in normal modes. If the recommender score for a particular show is between 90% and 99% then time compression is performed on the show.

The compression is also performed depending on other variables in the recommendation profile such as if the show was previously watched by a user, when and how far back the show was watched by the user, with whom the show was watched etc.

The invention also pertains to the audio arena, such as downloading of audio content from the web. The system can determine a recommender score for the audio and either record the audio without compression or record with compression based on the recommender score.

A more complete understanding of the invention as well as further features and advantages of the present invention will be obtained by reference to the following detailed description and drawings.

FIG. 1 shows an implicit recommender system in accordance with the prior art.

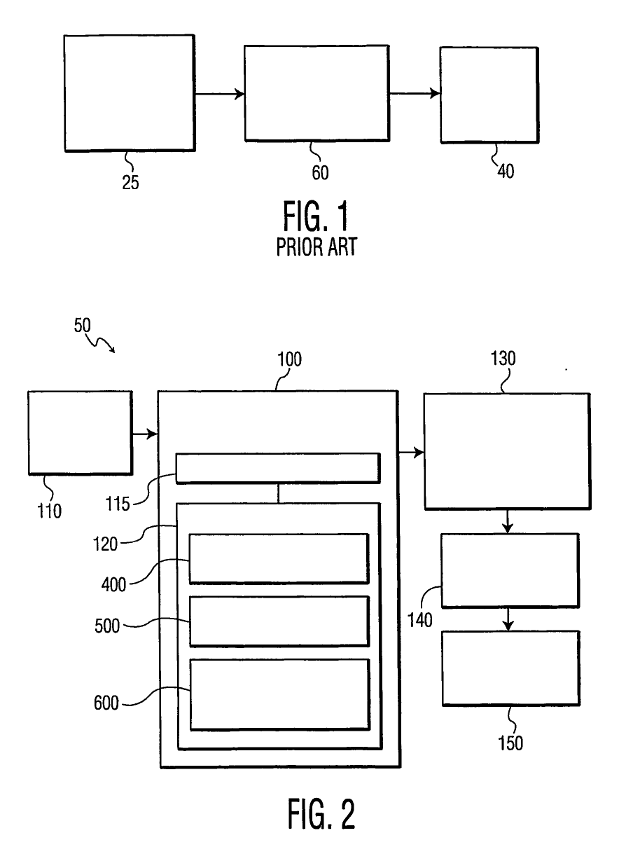

FIG. 2 shows a recommender/recording system in accordance with an embodiment of the invention.

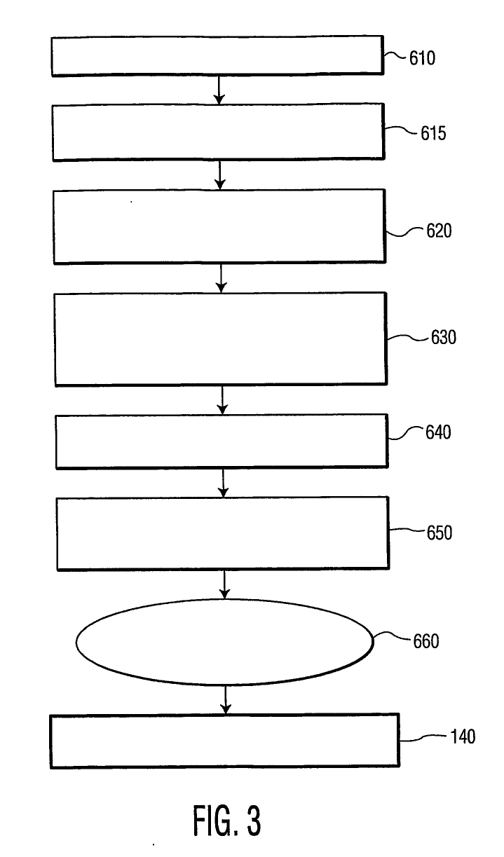

FIG. 3 shows a flow chart describing the program recommendation generation process of program recommendations along with compression of these programs if required in accordance with a preferred embodiment of the invention.

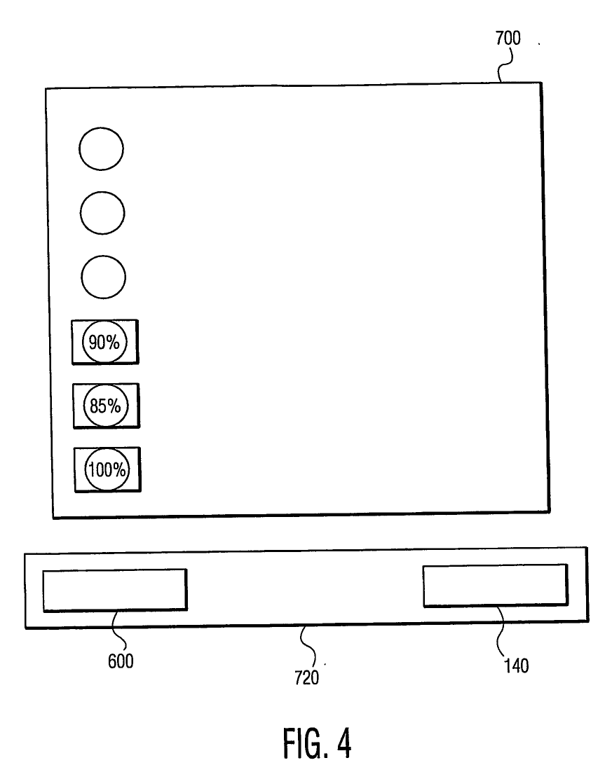

FIG. 4 shows a personal video recorder in accordance with the present invention.

FIG. 2 illustrates a television programming recommender/storage system 50 in accordance with the present invention. As shown in FIG. 2, the television programming recommender 100 evaluates each of the programs in an electronic programming guide (EPG) 110 to identify programs of interest to a particular viewer, for example, using a set-top terminal/television (not shown) using well known on-screen presentation techniques.

Although there are many types of recommender systems available which can be used with the present invention, the present invention is described with respect to an explicit/implicit recommender as described in U.S. Ser. No. 09/666,401. The television program recommender 100 generates television program recommendations based on a combined implicit/explicit program recommendation score. This recommender combines the explicit viewing preferences of viewers with their television viewing behavior (implicit preferences) to generate program recommendations. Generally, each viewer initially rates their preferences for various program attributes, including, for example, days and viewing times, channels, actors, and categories (genres) of television programs. An explicit viewer profile is created in 400. An implicit profile 500 is also generated and applied to each program. Using the invention in U.S. Ser. No. 09/666,401, a combined recommendation score is produced for each program at 600. If the recommendation score is above a certain threshold, the program is recommended at 130.

The program recommendations are then sent to the threshold comparator and compressor 140 to determine if the program to be recorded should be compressed and to what extent This determination is made by looking at the program recommender score the program received in 600 and comparing this score to compression thresholds. The compression thresholds are used to decide which programs are to be compressed and to what extent The thresholds can either be set by the manufacturer or they can be varied by the user. For example, one threshold ‘T’ may be 98% meaning a program must have a match of 98% with the contents of user profile. If, for example, the recommender score is greater than 98% match then the program is recorded without compression. Another threshold may be 89%<T<99%. If the recommender score is, for example, between 90%-98% then the program is compressed by 10%. In addition, the recommender score may not always be in the form of a percentage. It is understood that any form of recommender score can be used and compared to an appropriate threshold and then an appropriate compression ratio chosen. Table 1 shows a sample of thresholds and compression ratios for recommended shows.

TABLE 1

| Threshold | Compression |
|---|---|
| 98% < T | 0 |
| 89% < T < 98% | 10% |
| 85% < T < 89% | 15% |

The compressor 140 can be any known compression algorithm. One simple way of achieving compression is to skip frames during recording. In general, compression techniques are of two kinds—linear compression and non-linear compression. Linear compression is concerned with the application of compression to the entire video or audio stream without any regard to the information inherent in the stream. A few examples are linearly skipping frames at pre-specified time intervals or rendering them at a variable frame rate. One specific problem with discarding segments/frames is the presence of discontinuities. This problem is addressed by applying a windowing function or a smoothing filter.

Non-linear compression involves compression of video content taking into account the presence of semantic information. In the video domain this is often called video skimming. Numerous techniques exist for video skimming—one example—‘Video Skimming and Characterization through the combination of Image and Language Understanding Techniques’, Michael A. Smith and Takeo Kanade, Technical Report CMU-CS-97-111, CMU, Pittsburgh, 1997. The same report was published in, ‘M. A. Smith and T. Kanade, Video Skimming and Characterization through the combination of Image and Language Understanding, in Proc. IEEE International Workshop on Content-Based Access of Image and Video Database, 1998, pp. 61-70.

In video skimming, scenes or segments are characterized base on techniques in image and language understanding. Significant scenes are found and key frames and important corresponding audio are selected to create a video summary. It is understood that almost any form of compression can be used with the present invention.

Besides looking at only the recommender score for a program, the compression can also be performed taking into account whether or not the program has been previously viewed. If the recommender recommends a program, but the program has already been viewed by the user, then the system may compress such a recommended program by a predefined amount. This may occur in the threshold comparator 140 in FIG. 2 or in 660 in FIG. 3. Such a system in a preferred embodiment is user definable. The user decides what types of programs are compressed, for example, if a program has been previously viewed within the month then the viewer may want it compressed to a larger extent than if it was viewed six months ago. It is also possible that the recommender score may have been derived taking into account whether or not the program was previously viewed. Other options include storing who previously viewed the program. If the recommendation is being made for the same viewer's profile as the viewer who previously watched the program then the show may be compressed. If however, the recommendation is being made for a different viewer then compression may not occur. Systems that keep track of who is watching a program have been described in U.S. application Ser. Nos. Miroslav Trajkovic, Yong Yan, Antonio Colmenarez and Srinivas Gutta, Device Control via Image based Recognition, Ser. No. 09/685683, Filed Oct. 10, 2000.

A system that keeps track of the previously viewed shows is described in co-pending application “TRANSFORMATION OF RECOMMENDER SCORES DEPENDING UPON THE VIEWED STATUS OF TV SHOWS” by Srinivas Gutta, Attorney Docket No. US030153 (ID#703018) filed concurrently herewith, and hereby incorporated by reference.

The television program recommender 100 of FIG. 2 may be embodied as any computing device, such as a personal computer or workstation, that contains a processor 115, such as a central processing unit (CPU), and memory 120, such as RAM and ROM. In addition, the television programming recommender 100 may be embodied as any available television program recommender, such as the TiVo® system, or the television program recommenders described in U.S. patent application Ser. No. 09/466,406, filed Dec. 17, 1999, entitled METHOD AND APPARATUS FOR RECOMMENDING TELEVISION PROGRAMMING USING DECISION TREES,” and U.S. patent application Ser. No. 09/498,271, filed Feb. 4, 2000 entitled “BAYESIAN TV SHOW RECOMMENDER’, or any combination thereof, as modified herein that carry out the features and functions of the present invention.

FIG. 3 shows a flow chart of a recommendation compression system in accordance with an embodiment of the invention. The EPG is obtained for a time-period of interest at 610. Thereafter the appropriate explicit and implicit viewer profiles 400,500 are obtained for the viewer during step 615. The program recommendation generation process then converts the numeric ratings for each attribute from the explicit or implicit viewer profiles 400, 500 to the same numeric scale, if necessary during step 620.

The program recommendation generation process obtains (or calculates) the explicit recommendation score and the implicit recommendation score for each program identified in the EPG 110 for the time period of interest during step 630. The program recommendation generation process then calculates the combined recommendation score for each program during step 640. The combined recommendation score can be in many forms. It can be a numerical value such as from −1 . . . 1 or it can be a percentage value. The recommender score is provided at 650, a threshold is set (or has been set) at 660 to be compared to the recommender score to determine which programs will be recorded and which will not be recorded. Assume that a threshold is set such that if the recommender score is 75% or above, a program having such a score is recorded. The recommender score is then compared to the threshold. If it is above the threshold indicated for recording the program, then a decision must be made as to the amount of compression if any that will be used when storing the program. Either the threshold comparator 660 can determine the percent of compression to be used by comparing the recommender score to various thresholds or the compressor 140 can have associated recommender thresholds for different compression schemes. The video is then compressed at 140 based on the recommender score. If the recommender recommended the program highly then no compression or very little compression is used. If the program was not recommended highly then a high compression rate is used. This saves recording space by not wasting space for programs that a user may not be highly interested in.

This same technique can also be used in the audio domain. Recommenders can be used to determine whether different audio programs or music would be desirable for a listener. If the recommender result of such a recommender is high enough to cause recording of the audio but not high enough that it exceeds a threshold to avoid compression, then the audio is compressed in some form before storage. A form of compression that may be used for audio is non linear time compression as described in “Exploring Benefits of Non-Linear Time Compression by Livei He and Anoop Gupter, Proceedings of the 9^{th} ACM International Conference on Multimedia 2001, Sep. 30-Oct. 5, 2001, Ottawa, Ontario Canada. ACM, 2001, pages 382-391. In linear time compression, the speech is uniformly time compressed (e.g. every 100 ms of speech is compressed to 75 ms). In one form of non-linear time compression, pauses in the speech are removed and linear time compression is performed. Other forms of non-linear time compression are also known in the art.

FIG. 4 shows a Personal Video Recorder (PVR) 720 such as a TiVo® connected to a television 700. The PVR includes a recommender 600 and a compressor 140. The “Now Showing” screen of a Tivo® displays all of the programs currently stored on the hard disk. In this case they are Programs A-F. Many of these programs were selected to be specifically recorded by the viewer (such as Programs A-C). The other programs are recommender programs as shown by the square surrounding the circle. Inside the circle is either the recommender score which correlates to a compression ratio, or it can be the specific compression ratio. For example, as shown in FIG. 3, Program D has been compressed by 10%, Program E by 15% and Program F was not compressed at all.

Alternative embodiments may use color coding to indicate the compression percentage or the shows can be ordered based on the amount they are compressed.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A recording device for recording recommended audio and/or visual programs, comprising:
a recommender for recommending programs to be recorded and providing a recommender score;
a comparator for comparing the recommender score to at least one threshold to determine the amount of compression to be used on the program before storage;
a compressor for receiving the recommender score and for compressing the program based on the output of the comparator, and
a storage medium for storing the program.

2. The recording device as claimed in claim 1, wherein the compression is a time-based compression.

3. The recording device as claimed in claim 1, wherein the compression is performed on visual programs by skipping frames of the program.

4. The recording device as claimed in claim 1, wherein the compression is linear compression.

5. The recording device as claimed in claim 1, wherein the compression is non linear compression.

6. The recording device as claimed in claim 1, further including a viewer history device for determining whether or not a program has been previously viewed, and wherein the compressor compresses previously viewed programs which are recommended for recording.

7. The recording device as claimed in claim 6, wherein the viewer history device stores the date when programs were previously viewed, and wherein compression is performed on programs based on the length of time since last viewing by the viewer.

8. The recording device as claimed in claim 7, wherein the amount of compression is user definable.

9. The recommender as claimed in claim 7, wherein the viewer history stores the identification of the viewers who watched the previous programs, and wherein the compressor compresses a program based on whether or not the recommended program are for the same viewer who previously watched the program.

10. The recommender as claimed in claim 1, wherein recommendation thresholds are set and different compression levels are used depending on where the recommendation score falls around the thresholds.

11. A recommender system for recommending audio and/or visual programs, comprising:
a recommender for recommending programs to be recorded and providing a recommender score indicating the program is recommended for recording;
a comparator for comparing the recommender score to at least one threshold to determine the amount of compression to be used on the program before storage;
a compressor for receiving the recommender score and for. compressing the program based on the recommender score.

12. A recommender system as claimed in claim 11, wherein the compression is a time-based compression.

13. A recommender system as claimed in claim 11, wherein the compression is performed on visual programs by skipping frames of the program.

14. A recommender system as claimed in claim 11, wherein the compression is linear compression.

15. A recommender system as claimed in claim 11, further including a viewer history device for determining whether or not a program has been previously viewed, and wherein the compressor compresses previously viewed programs which are recommended for recording.

16. The recommender system as claimed in claim 11, wherein the viewer history device stores the date when programs were previously viewed, and wherein compression is performed on programs based on the length of time since last viewing by the viewer.

17. A recommender system as claimed in claim 16, wherein the amount of compression is user definable.

18. The recommender as claimed in claim 16, wherein the date when the recommended program was previously viewed is used to determine the amount of compression.

19. The recommender as claimed in claim 15, wherein the viewer history device stores the identification of the viewers who watched the previous programs, and wherein the compressor compresses a program based on whether or not the recommended program are for the same viewer who previously watched the program.

20. The recommender as claimed in claim 11, wherein recommendation thresholds are set and different compression levels are used depending on where the recommendation score falls around the thresholds.

21. A method for recommending audio and/or visual programs, comprising:
recommending programs to be recorded and providing a recommender score indicating the program is recommended for recording;
comparing the recommender score to at least one threshold to determine the amount of compression to be used on the program before storage;
compressing the program based on the recommender score.

22. A method as claimed in claim 21, the step of compressing performs time-based compression.

23. A method as claimed in claim 21, wherein the step of compressing performs compression on visual programs by skipping frames of the program.

24. A method as claimed in claim 21, wherein the step of compressing performs linear compression.

25. A method as claimed in claim 21, further including a step of storing a viewer history which stores whether or not a program has been previously viewed, and wherein the step of compressing compresses previously viewed programs which are recommended for recording.

26. A method as claimed in claim 21, wherein the step of storing the viewer history stores the date when programs were previously viewed, and wherein the step of compressing compresses programs based on the length of time since last viewing by the viewer.

27. A method as claimed in claim 26, wherein the step of compressing compresses by an amount that is user definable.

28. The method as claimed in claim 26, wherein the date when the recommended program was previously viewed is used to determine the amount of compression.

29. The method as claimed in claim 25, wherein the step of storing the viewer history stores the identification of the viewers who watched the previous programs, and wherein the step of compressing compresses a program based on whether or not the recommended program are for the same viewer who previously watched the program.

30. The method as claimed in claim 21, further including the step of setting recommendation score thresholds for different compression levels and compressing based on where the recommendation score falls around the thresholds.
